(19) United States
(12) Patent Application Publication
(10) Pub. No.: US 2013/0052525 A1
(43) Pub. Date: Feb. 28, 2013

(54) SODIUM SECONDARY BATTERY

(71) Applicants: Jun-ichi KAGEURA, Tsukuba-shi (JP); Satoru KUZE, Tsukuba-shi (JP)

(72) Inventors: Jun-ichi KAGEURA, Tsukuba-shi (JP); Satoru KUZE, Tsukuba-shi (JP)

(73) Assignee: SUMITOMO CHEMICAL COMPANY, LIMITED, Tokyo (JP)

(21) Appl. No.: 13/588,238

(22) Filed: Aug. 17, 2012

(30) Foreign Application Priority Data
Aug. 24, 2011 (JP) 2011-182320

(51) Int. Cl. H01M 10/056; H01M 4/133

(52) U.S. Cl. 429/200

(57) ABSTRACT

The present invention relates to a sodium secondary battery comprising a first electrode comprising a carbonaceous material which can be doped and dedoped with a sodium ion, a second electrode, and a non-aqueous electrolytic solution in which an electrolyte salt is dissolved in a non-aqueous solvent, wherein the non-aqueous electrolytic solution comprises a cyclic carbonate containing an unsaturated bond, a cyclic carbonate containing fluorine, or both, in the range of 0.01% by volume or more and 10% by volume or less relative to the non-aqueous electrolytic solution.

This nonprovisional application claims priority under 35 U.S.C. §119(a) on Patent Application No. 2011-182320 filed in JAPAN on Aug. 24, 2011, the entire contents of which are hereby incorporated by reference.

### FIELD OF THE INVENTION

The present invention relates to a sodium secondary battery.

### BACKGROUND OF THE INVENTION

A sodium secondary battery using a non-aqueous electrolytic solution can generate high voltage compared to a battery of an aqueous electrolytic solution, and thus is suitable as a battery having high energy density. Furthermore, sodium is a material that is rich in the resources and cheap, and thus is put into practical use, whereby it is expected that a large-sized power supply can be supplied in large amounts.

A sodium secondary battery usually has a positive electrode containing a positive electrode active material which can be doped and dedoped with a sodium ion and a negative electrode containing a negative electrode active material which can be doped and dedoped with a sodium ion, and a non-aqueous electrolytic solution in which an electrolyte salt is dissolved in a non-aqueous solvent.

A sodium secondary battery using a non-aqueous electrolytic solution in which an electrolyte salt made of sodium perchlorate in a non-aqueous solvent made of a saturated cyclic carbonate such as propylene carbonate, as a non-aqueous electrolytic solution of the sodium secondary battery, has been studied (JP2010-251283A).

### SUMMARY OF THE INVENTION

However, it cannot be said that this sodium secondary battery is sufficient from the viewpoint of discharge capacity. The object of the present invention is to provide a sodium secondary battery having high discharge capacity.

The present invention provides the following:

<1> A sodium secondary battery comprising a first electrode comprising a carbonaceous material which can be doped and dedoped with a sodium ion, a second electrode, and a non-aqueous electrolytic solution in which an electrolyte salt is dissolved in a non-aqueous solvent, wherein the non-aqueous electrolytic solution comprises a cyclic carbonate containing an unsaturated bond, a cyclic carbonate containing fluorine, or both, in the range of 0.01% by volume or more and 10% by volume or less relative to the non-aqueous electrolytic solution.
<2> The sodium secondary battery according to <1>, wherein the cyclic carbonate containing fluorine is 4-fluoro-1,3-dioxolane-2-on.
<3> The sodium secondary battery according to <1> or <2>, wherein the carbonaceous material is a non-activated carbonaceous material.
<4> The sodium secondary battery according to any one of <1> to <3>, further comprising a separator between the first electrode and the second electrode.

### BRIEF DESCRIPTION OF THE DRAWINGS

FIG. 1 is a schematic view of a sodium secondary battery.

### DESCRIPTION OF PREFERRED EMBODIMENTS

### <Sodium Secondary Battery>

A sodium secondary battery has a first electrode having a carbonaceous material which can be doped and dedoped with a sodium ion, a second electrode, and a non-aqueous electrolytic solution, and usually further having a separator. The first electrode has a carbonaceous material which can be doped and dedoped with a sodium ion, and particularly when the second electrode has a sodium metal or sodium alloy, the first electrode acts as a positive electrode, and when the second electrode has a transition metal compound, the first electrode acts as a negative electrode.

The sodium secondary battery can be usually produced by obtaining an electrode group by laminating and winding a negative electrode, a separator, and a positive electrode, storing this electrode group into a battery can, and impregnating the electrode group with the non-aqueous electrolyte solution.

Herein, examples of the shape of the electrode group include such a shape that the cross section taken perpendicular to the winding axis of the electrode group is circular, oval, rectangular, or round-cornered rectangular. Also, examples of the shape of the battery include shapes such as paper-type, coin-type, cylindrical, and prismatic.

### <Non-Aqueous Electrolytic Solution>

A non-aqueous electrolytic solution used in the sodium secondary battery is a non-aqueous electrolytic solution in which an electrolyte salt is dissolved in a non-aqueous solvent, wherein the non-aqueous electrolytic solution contains a cyclic carbonate containing an unsaturated bond, a cyclic carbonate containing fluorine, or both, in the range of 0.01% by volume or more and 10% by volume or less relative to the non-aqueous electrolytic solution.

The example of the cyclic carbonate containing an unsaturated bond includes vinyl ethylene carbonate (VEC), methyl vinylene carbonate (MVC), and dimethyl vinylene carbonate (DMVC).

The example of the cyclic carbonate containing fluorine includes 4-fluoro-1,3-dioxolane-2-on (hereinafter, sometimes referred to as EEC or fluoroethylene carbonate), and difluoroethylene carbonate (DFEC: trans or cis-4,5-difluoro-1,3-dioxolane-2-on).

The cyclic carbonate containing fluorine is preferably fluoroethylene carbonate.

The cyclic carbonate containing an unsaturated bond may be one kind, and two or more kinds (for example, two to four kinds) of the cyclic carbonates containing an unsaturated bond may be combined. Similarly, the cyclic carbonate containing fluorine may be one kind, and two or more kinds (for example, two to four kinds) of the cyclic carbonates containing fluorine may be combined.

The rate of a cyclic carbonate containing an unsaturated bond, a cyclic carbonate containing fluorine or both contained in the non-aqueous electrolytic solution is in the range of 0.01% by volume or more and 10% by volume or less, preferably in the range of 0.1% by volume or more and 8% by volume or less, more preferably in the range of 0.5% by volume or more and 5% by volume or less, and further preferably in the range of 0.7% by volume or more and 2.5% by volume or less, relative to the non-aqueous electrolytic solution.

### <Electrolyte Salt>

Examples of the electrolyte salt used in the non-aqueous electrolytic solution include NaClO₄, NaPF₆, NaAsF₆, NaSbF₆, NaBF₄, NaCF₃SO₃, NaN(SO₂CF₃)₂, lower aliphatic carboxylic acid sodium salts, and NaAlCl₄, and a mixture of two or more kinds thereof may be used. Among them, a fluorine-containing sodium salt containing at least one kind selected from the group consisting of NaPF₆, NaAsF₆, NaSbF₆, NaBFₒ NaCF₃SO₃, and NaN(SO₂CF₃)₂ is preferably used.

### <Non-Aqueous Solvent>

Examples of the non-aqueous solvent used in the non-aqueous electrolytic solution include carbonates such as propylene carbonate, ethylene carbonate, dimethyl carbonate, diethyl carbonate, ethyl methyl carbonate, isopropyl methyl carbonate, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; and sulfur-containing compounds such as sulfolane, dimethyl sulfoxide, and 1,3-propane sultone. As the non-aqueous solvent, a mixture of two or more thereof may be used.

The concentration of the electrolyte in the non-aqueous electrolytic solution is usually about 0.1 mol/L to about 2 mol/L and preferably about 0.3 mol/L to about 1.5 mol/L.

### <First Electrode>

The first electrode used in the sodium secondary battery has a carbonaceous material which can be doped and dedoped with a sodium ion as an electrode active material. The first electrode comprises a current collector, and an electrode mixture containing the electrode active material, which is supported on the current collector. The electrode mixture contains a conductive material and a binder, in addition to the above-mentioned electrode active material, as necessary.

The electrode active material of the first electrode may contain a material which can be doped and dedoped with a sodium ion, such as a chalcogen compound (e.g., oxide, or sulfide), a nitride, a metal or alloy, in addition to the carbonaceous material.

### <Carbonaceous Material>

An example of the carbonaceous material includes non-graphitized carbonaceous materials (e.g., carbon black, pyrolytic carbons, carbon fiber, and organic material calcined body). The carbonaceous material is preferably a non-graphitized carbonaceous material (hereinafter, sometimes referred to as a hard carbon), and examples thereof include carbon microbeads made of a non-graphitized carbonaceous material, and specifically include ICB manufactured by Nippon Carbon Co., Ltd. (trade name: NICABEADS).

Examples of the shape of the particles constituting the carbonaceous material include shapes of flake such as natural graphite, sphere such as mesocarbon microbeads, fiber such as graphitized carbon fiber, and aggregate of fine particles. When the shape of the particles constituting the carbonaceous material is spherical, the average particle size is preferably in the range of 0.01 μm or more and 30 μm or less and more preferably in the range of 0.1 μm or more and 20 μm or less.

The non-graphitized carbonaceous material is preferably a non-activated carbonaceous material not subjected to an activation treatment and particularly preferably a non-activated carbonaceous material subjected to a surface treatment. The surface treatment is carried out, whereby the charge and discharge capacity of the resultant sodium secondary battery is increased.

Herein, the “activation treatment” means a treatment promoting porosity and activation of the carbonaceous material, and the specific treatment method includes a chemical activation method and a gas activation method.

The “surface treatment” means a treatment for removing a surface functional group of the carbonaceous material, and the specific treatment method includes a method of heat-treating at a temperature in the range of 600° C. or more and 2000° C. or less, preferably in the range of 800° C. or more and 1800° C. or less, and more preferably in the range of 1400° C. or more and 1800° C. or less, in an inert gas atmosphere.

The non-activated carbonaceous material is more likely to be doped and dedoped with a sodium ion than the non-activated carbonaceous material, and by using the non-activated carbonaceous material as an electrode active material, the irreversible capacity of the secondary battery can be made smaller.

### <Organic Material Calcined Body>

As the organic material calcined body, among the carbonaceous materials obtained by carbonization (calcination) of various organic materials, a carbonaceous material which can be doped and dedoped with a sodium ion may be used. The non-graphitized carbonaceous material, which is a suitable carbonaceous material, can be obtained by calcining an organic material less likely to form a graphite structure.

An example of the organic material, which is a raw material of the organic material calcined body, includes natural mineral resources such as petroleum and coal, various synthetic resins (thermosetting resins, thermoplastic resins, and the like) synthesized using these resources as raw materials, various plant residue oils such as petroleum pitch, coal pitch, and pitch for spinning, and plant-derived organic materials such as wood, and these can be used singly or in a combination of two or more.

Examples of the synthetic resins include phenol resin, resorcinol resin, furan resin, epoxy resin, urethane resin, unsaturated polyester resin, melamine resin, urea resin, aniline resin, bismaleimide resin, benzoxazine resin, polyacrylonitrile resin, polystyrene resin, polyamide resin, cyanate resin, and ketone resin, which can be used singly or in a combination of two or more. These resins may contain a curing agent and an additive. An example of the curing method includes, when a phenolic resin is used, a heat curing method, a thermal oxidation method, an epoxy curing method, and an isocyanate curing method. When an epoxy resin is used, an example of the curing method includes a phenolic resin curing method, an acid anhydride curing method, and an amine curing method.

The organic material is preferably an organic material having an aromatic ring. The organic material is used, whereby a carbonaceous material which can be doped and dedoped with a sodium ion can be obtained in good yield. Whereby, the load on the environment and the production cost can be made smaller, and the industrial utility value is higher.

Examples of the organic material having an aromatic ring include, among the synthetic resins described above, phenolic resins (novolac-type phenolic resins, resol-type phenolic resins, and the like), epoxy resins (bisphenol-type epoxy resins, novolac-type epoxy resins, and the like), aniline resins, bismaleimide resins, and benzoxazine resins, which can be used singly or in a combination of two or more. These resins may contain a curing agent and an additive.

The organic material having an aromatic ring is preferably an organic material produced by polymerizing a phenol or a derivative thereof with an aldehyde compound. Since the organic material is cheap among the organic materials having an aromatic ring and is also produced in a large amount, a carbonaceous material obtained by carbonizing the organic material is a preferable carbonaceous material.

An example of the organic material obtained by polymerizing a phenol or a derivative thereof with an aldehyde compound includes phenolic resins. The phenolic resin is cheap and is also produced in a large amount, thus is preferable as a material of the carbonaceous material. When a carbonaceous material obtained by carbonizing a phenolic resin is used as an electrode active material of the secondary battery of the present invention, charge and discharge capacity of the sodium secondary battery and discharge capacity when repeating charge and discharge are particularly large, thus the carbonaceous material obtained by carbonizing a phenolic resin is preferable. The phenolic resin has a structure with a developed three-dimensional crosslinking, and it is presumed that a carbonaceous material obtained by carbonizing the resin becomes also a carbonaceous material having a structure with a developed three-dimensional crosslinking derived from the structure. Whereby, the discharge capacity is considered to be particularly large.

Examples of the phenol or the derivative thereof include phenol, o-cresol, m-cresol, p-cresol, catechol, resorcinol, hydroquinone, xylenol, pyrogallol, bisphenol A, bisphenol F, p-phenylphenol, p-tert-butylphenol, p-tert-octylphenol, α-naphthol, and β-naphthol, which can be used singly or in a combination of two or more.

Examples of the aldehyde compound include formaldehyde, paraformaldehyde, trioxane, acetaldehyde, propionaldehyde, polyoxymethylene, chloral, furfural, glyoxal, n-butylaldehyde, caproaldehyde, allylaldehyde, benzaldehyde, crotonaldehyde, acrolein, tetraoxymethylene, phenylacetaldehyde, o-tolualdehyde, and salicylaldehyde, which can be used singly or in a combination of two or more.

Examples of the phenolic resin include resol-type phenolic resins, and novolac-type phenolic resins. The resol-type phenolic resin can be obtained by polymerizing a phenol or a derivative thereof and an aldehyde compound in the presence of a basic catalyst. The novolac-type phenolic resin can be obtained by polymerizing a phenol or a derivative thereof and an aldehyde compound in the presence of an acidic catalyst.

When a self-curing resol-type phenolic resin is used, an acid or a curing agent may be added to the resol-type phenolic resin, or a novolac-type phenolic resin may be added for decreasing the degree of curing. A combination thereof may be also added to the resol-type phenolic resin.

As a novolac-type phenolic resin, a type called as a random novolac, which has methylene groups bonded equally at an ortho position and a para position (this type can be obtained by a method of subjecting a phenol or a derivative thereof and an aldehyde compound to a condensation reaction under a normal pressure at 100° C. for several hours using a catalyst of a known organic acid and/or inorganic acid and removing water and unreacted monomers from the obtained condensate), and a type called as a high-ortho novolac, which has more methylene groups bonded at an ortho position (this type can be obtained by a method of subjecting a phenol or a derivative thereof and an aldehyde compound to an addition condensation reaction under a weak acidic condition using a metallic salt catalyst such as zinc acetate, lead acetate, or zinc naphthenate, then continuing a condensation reaction under dehydration directly or with an addition of an acidic catalyst, and removing unreacted substances as necessary) are known.

As the organic material having an aromatic ring in its molecular structure, a wide variety of organic materials can be also utilized.

The synthetic resin is generally a polymer synthesized by polymerizing monomers. As the organic material having an aromatic ring, an organic material synthesized by polymerizing several to several tens of monomers can be also used.

When a phenol or a derivative thereof and an aldehyde compound are polymerized, a by-product may be formed or an unpolymerized product may remain. Such a by-product or unpolymerized product can also be utilized as an organic material, so that the waste is reduced, therefore the load on the environment can be reduced, and a carbonaceous material can be obtained at a reduced cost, and the industrial utility value is higher.

Examples of the plant-derived organic materials include wood and the like. A charcoal obtained by carbonizing a plant-derived organic material is preferable as a carbonaceous material used as an electrode active material. As the wood, waste lumber, waste wood generated in wood processing such as a sawdust, wood from forest thinning and the like can be also utilized. The constituents of the wood generally include cellulose, hemicellulose and lignin as three main constituents, and lignin is an organic material having an aromatic ring, thus is preferable.

An example of the wood includes gymnosperm such as Cycadopsida, Ginkgopsida, Coniferopsida (Japanese cedar, Japanese cypress, Japanese red pine, etc.), and Chlamydospermopsida, angiosperm such as broad-leaved trees (Quercus crispula, beech, poplar, Ulmus davidiana, Quercus, etc.), a herbaceous plant, Palmae, and a bamboo.

Among the above-mentioned woods, Japanese cedar is used broadly as a building material and sawdust of Japanese cedar is generated in the processing. The sawdust of Japanese cedar is a preferred organic material, since the load on the environment can be reduced, and also a carbonaceous material can be obtained at a reduced cost. Also, bincho charcoal, which is obtained by carbonizing Quercus, is preferable as a carbonaceous material used as an electrode active material.

Meanwhile, by using, as an electrode active material, a carbonaceous material obtained by carbonization (calcination) of a plant residual oil, resources can be utilized effectively, and the industrial utility value is higher.

An example of the plant residual oil includes various residual oils generated in the production of various petrochemical products such as ethylene. A specific example of the plant residual oil includes a distillation residual oil, a fluid catalytic cracking residual oil, a hydrodesulfurized oil therefrom, and a petroleum heavy oil containing a mixed oil thereof. Among them, a residual oil generated in the production of a petrochemical product having an aromatic ring is preferable, and the residual oil specifically includes a residual oil generated in the production of resorcinol.

The carbonaceous material used as an electrode active material can be obtained by carbonization (calcination) of one or more kinds of organic materials among the above-mentioned various organic materials. The carbonaceous material obtained by this carbonization step is a non-activated carbonaceous material. The carbonization temperature is preferably in the range of 800° C. or more and 2500° C. or less. The carbonization is preferably carried out in an inert gas atmosphere. An organic material may be carbonized as it is, or a heated product obtained by heating an organic material at 400° C. or less in the presence of an oxidizing gas may be carbonized in an inert gas atmosphere. An example of the inert gas includes nitrogen, argon, and CO₂, and an example of the oxidizing gas includes air, H₂O, CO, and O₂. The carbonization may be conducted under a reduced pressure. For the heating and carbonization, a facility such as a rotary kiln, a roller hearth kiln, a pusher kiln, a multistage furnace, or a fluidized bed furnace may be used. A rotary kiln is a facility for universal use.

The carbonaceous material obtained by carbonization (calcination) may be pulverized as necessary. Pulverization can be conducted using a pulverizer for fine pulverization such as an impact friction mill, a centrifugal mill, a ball mill (e.g. a tube mill, a compound mill, a conical ball mill, and a rod mill), a vibration mill, a colloid mill, a disk attrition mill, or a jet mill. A ball mill is a pulverizer generally used. In pulverizing, in order to suppress contamination of a metallic powder into the carbonaceous material, the portion being in contact with the carbonaceous material in these pulverizers may be constituted by a nonmetal material such as alumina and agate. By pulverization, the carbonaceous material is pulverized so that the average particle size of the particle constituting the material is usually 50 μm or less, preferably 30 μm or less, and particularly preferably 10 μm or less.

The non-activated carbonaceous material may be surface treated in the above-mentioned conditions. In addition, the surface area of the carbonaceous material is increased by pulverization, then the surface-treated carbonaceous material is used as the electrode active material of the first electrode, whereby the charge and discharge capacity of the secondary battery to be obtained is increased.

### <Other Electrode Active Material in First Electrode>

As other electrode active material in the first electrode, examples of oxide include Li₄Ti₅O₁₂. Examples of sulfide include TiS₂, NiS₂, FeS₂, and Fe₃S₄. Examples of nitride include Li₃₋ₓMₓN (wherein M is a transition metal element, 0≦x≦3) such as Li₃N and Li_{2.6}Co_{0.4}N, and Na₃₋ₓMₓN (wherein M is a transition metal element, 0≦x≦3) such as Na₃N and Na_{2.6}Co_{0.4}N.

These carbonaceous materials, oxides, sulfides and nitrides may be used in combination and may be either crystalline or amorphous. These carbonaceous materials, oxides, sulfides and nitrides are mainly supported on a current collector, and used as an electrode.

Specifically, examples of the metal as the electrode active material of the first electrode include tin metals, silicon metals, bismuth metals, and germanium metals. Examples of the alloy include alloys of two or more kinds of metals selected from the group consisting of tin metals, silicon metals, bismuth metals, and germanium metals, and include alloys such as Si—Zn, Cu₂Sb, and La₃Ni₂Sn₇. These metals and alloys are supported on a current collector in combination with a carbonaceous material, and are used as an electrode active material.

### <Binder>

Examples of the binder in the first electrode include a polymer of a fluorine compound. Examples of the fluorine compound include fluorinated alkyl (carbon number of 1 to 18) (meth)acrylates, perfluoroalkyl (meth)acrylates [such as perfluorododecyl (meth)acrylate, perfluoro-n-octyl (meth)acrylate, and perfluoro-n-butyl (meth)acrylate], perfluoroalkyl-substituted-alkyl (meth)acrylates [such as perfluorohexylethyl (meth)acrylate and perfluorooctylethyl (meth)acrylate], perfluorooxyalkyl (meth)acrylates [such as perfluorododecyloxyethyl (meth)acrylate and perfluorodecyloxyethyl (meth)acrylate], fluorinated alkyl (carbon number of 1 to 18) crotonates, fluorinated alkyl (carbon number of 1 to 18) malates and fumarates, fluorinated alkyl (carbon number of 1 to 18) itaconates, fluorinated alkyl-substituted-olefins (carbon number of about 2 to 10, fluorine number of about 1 to 17) such as perfluorohexylethylene, fluorinated olefins having about 2 to 10 carbon atoms and about 1 to 20 fluorine atoms, in which a fluorine atom bonds to a carbon atom with a double bond, tetrafluoroethylene, trifluoroethylene, vinylidene fluoride, and hexafluoropropylene. Further, the binder also includes a copolymer of a fluorine compound and a monomer containing an ethylenic double bond and being free from fluorine set forth below.

Other examples of the binder include a non-fluorinated polymer. The non-fluorinated polymer is a polymer free from fluorine. The electrode in the present invention preferably has a non-fluorinated polymer, so that the initial irreversible capacity of a sodium secondary battery can be decreased. Examples of the non-fluorinated polymer include an addition polymer of a monomer containing an ethylenic double bond and being free from fluorine. Examples of such a monomer include (meth)acrylic acid ester monomers such as (cyclo)alkyl (carbon number of 1 to 22) (meth)acrylates [such as methyl (meth)acrylate, ethyl (meth)acrylate, n-butyl (meth)acrylate, iso-butyl (meth)acrylate, cyclohexyl (meth)acrylate, 2-ethylhexyl (meth)acrylate, isodecyl (meth)acrylate, lauryl (meth)acrylate, and octadecyl (meth)acrylate]; aromatic ring-containing (meth)acrylates [such as benzyl (meth)acrylate and phenylethyl (meth)acrylate]; alkylene glycol or dialkylene glycol (carbon number of the alkylene group of 2 to 4) mono(meth)acrylates [such as 2-hydroxyethyl (meth)acrylate, 2-hydroxypropyl (meth)acrylate, and diethylene glycol mono(meth)acrylate]; (poly)glycerol (degree of polymerization of 1 to 4) mono(meth)acrylates; and multifunctional (meth)acrylates [such as (poly)ethylene glycol (degree of polymerization of 1 to 100) di(meth)acrylates, (poly)propylene glycol (degree of polymerization of 1 to 100) di(meth)acrylates, 2,2-bis(4-hydroxyethylphenyl)propane di(meth)acrylate, and trimethylolpropane tri(meth)acrylate]; (meth)acrylamide monomers such as (meth)acrylamide and (meth)acrylamide derivatives [such as N-methylol (meth) acrylamide and diacetone acrylamide]; cyano group-containing monomers such as (meth)acrylonitrile, 2-cyanoethyl (meth)acrylate, and 2-cyanoethyl acrylamide; styrenic monomers including styrene and styrene derivatives having a carbon number of 7 to 18 [such as α-methylstyrene, vinyl toluene, p-hydroxystyrene, and divinylbenzene]; diene monomers such as alkadienes having a carbon number of 4 to 12 [such as butadiene, isoprene, and chloroprene]; alkenyl ester monomers such as carboxylic acid (carbon number of 2 to 12) vinyl esters [such as vinyl acetate, vinyl propionate, vinyl butyrate, and vinyl octanoate]; and carboxylic acid (carbon number of 2 to 12) (meth)allyl esters, [such as (meth)allyl acetate, (meth)allyl propionate, and (meth)allyl octanoate]; epoxy group-containing monomers such as glycidyl (meth)acrylate and (meth)allyl glycidyl ether; monoolefins of monoolefins having a carbon number of 2 to 12 [such as ethylene, propylene, 1-butene, 1-octene, and 1-dodecene]; monomers containing a halogen atom other than fluorine such as monomers containing a chlorine, bromine or iodine atom, vinyl chloride and vinylidene chloride; (meth)acrylic acids and alkali salts thereof such as acrylic acid and methacrylic acid; and conjugated double bond-containing monomers such as butadiene and isoprene. Also, examples of an addition polymer may be a copolymer such as an ethylene-vinyl acetate copolymer, a styrene-butadiene copolymer, and an ethylene-propylene copolymer. Further, a carboxylic acid vinyl ester polymer may be partially or totally saponified like polyvinyl alcohol.

Other examples of the binder include polysaccharides such as starch, methylcellulose, carboxymethyl cellulose, hydroxymethyl cellulose, hydroxyethyl cellulose, hydroxypropyl cellulose, carboxymethylhydroxyethyl cellulose, and nitrocellulose, and derivatives thereof; phenolic resins; melamine resins; polyurethane resins; urea resins; polyimide resins; polyimide resins; polyamide-imide resins; petroleum pitch; and coal pitch. A plurality of types among the above-mentioned binders may be used in the first electrode.

The rate of the binder in the electrode in the present invention is usually about 0.5 parts by weight to about 30 parts by weight and preferably about 2 parts by weight to about 20 parts by weight, based on 100 parts by weight of the carbonaceous material.

### <Method for Producing First Electrode>

The method for producing a first electrode will be described below. The first electrode is an electrode obtained by supporting, on a current collector, an electrode mixture containing a carbonaceous material which can be doped and dedoped with a sodium ion, a binder and, as necessary, a conductive material and the like, and is usually in a sheet form. Examples of the method for producing a first electrode include a method of applying, on a current collector, an electrode mixture paste obtained by adding a solvent to a carbonaceous material, a binder, a conductive material, and the like, or immersing a current collector in the electrode mixture paste, and drying the obtained substance. The solvent in the electrode mixture paste is removed by drying, and an electrode mixture is bound on the current collector to obtain an electrode.

Examples of the solvent used in the electrode mixture paste include an organic solvent. The organic solvent may be either a polar solvent or a non-polar solvent. An example of the polar solvent includes amides such as N-methyl-2-pyrrolidone, N,N-dimethylacetamide, and dimethylformamide; alcohols such as isopropyl alcohol, ethyl alcohol, and methyl alcohol; ethers such as propylene glycol dimethyl ether; and ketones such as acetone, methyl ethyl ketone, and methyl isobutyl ketone. An example of the non-polar solvent includes hexane, and toluene. In addition, water can be used as the solvent, and water is preferable for suppressing the electrode production cost.

Examples of a material for a current collector of the first electrode include metals such as nickel, aluminum, titanium, copper, gold, silver, platinum, an aluminum alloy and a stainless steel, those formed by plasma spraying or arc spraying of a carbonaceous material, an activated carbon fiber, nickel, aluminum, zinc, copper, tin, lead, or an alloy thereof, and a conductive film in which a conductive material is dispersed in a resin such as rubber and a styrene-ethylene-butylene-styrene copolymer (SEBS). Examples of the form of the current collector include foil, flat plate, mesh, net, lath, perforated metal, embossed, and combinations thereof (e.g., mesh-like flat plate). Concavities and convexities may be formed on the surface of the current collector by etching.

The method of applying the electrode mixture paste in the first electrode on the current collector is not particularly limited, and examples thereof include a doctor blade method, a slit die coating method, a screen coating method, a curtain coating method, a knife coating method, a gravure coating method, and an electrostatic spray method. Also, drying after the application may be carried out by heat treatment, and may be carried out by air blast drying, vacuum drying, and the like. When drying is carried out by heat treatment, the temperature is usually in the range of from about 50° C. to about 150° C. Pressing may be carried out after drying. The press method includes methods such as metal mold press and roll press. The first electrode can be produced by the above-mentioned method. The thickness of the electrode is usually in the range of from about 5 μm to about 500 μm.

### <Second Electrode>

A second electrode contains, for example, a sodium metal, a sodium alloy, or a transition metal compound which can be doped and dedoped with a sodium ion, as an electrode active material.

The second electrode may comprise a current collector, and an electrode mixture containing the electrode active material, which is supported on the current collector. The electrode mixture contains a conductive material and a binder, in addition to the electrode active material, as necessary.

When the second electrode has a transition metal compound which can be doped and dedoped with a sodium ion as an electrode active material, the first electrode of the sodium secondary battery of the present invention acts as a negative electrode, and the second electrode acts as a positive electrode. In this case, an electrode supporting, on a positive current collector, a positive electrode mixture containing an electrode active material having a transition metal compound which can be doped and dedoped with a sodium ion can be used as the positive electrode.

### <Transition Metal Compound>

An example of the transition metal compound includes sodium transition metal compounds, and a specific examples of the sodium transition metal compounds includes the following compounds:

oxides represented by NaM¹ₐ₁O₂ such as NaFeO₂, NaMnO₂, NaNiO₂ and NaCoO₂, oxides represented by Na_{0.44}Mn₁₋ₐ₂M¹ₐ₂O₂, oxides represented by Na_{0.7}Mn₁₋ₐ₂M¹ₐ₂O_{2.05} (M is one or more transition metal elements, 0<a1<1, 0≦a2<1);

oxides represented by Na_{b}M²_{c}Si₁₂O₃₀ such as Na₆Fe₂Si₁₂O₃₀ and Na₂Fe₅Si₁₂O₃₀ (M² is one or more kinds of transition metal elements, 2≦b≦6, 2≦c≦5);

oxides represented by Na_{d}M³ₑSi₆O₁₈ such as Na₂Fe₂Si₆O₁₈ and Na₂MnFeSi₆O₁₈ (M³ is one or more transition metal elements, 2≦d≦6, 1≦e≦2);

oxides represented by Na_{f}M⁴_{g}Si₂O₆ such as Na₂FeSiO₆ (M⁴ is one or more kinds selected from the group consisting of transition metal elements, Mg, and Al, 1≦f≦2, 1≦g≦2);

phosphates such as NaFePO₄, NaMnPO₄, and Na₃Fe₂(PO₄)₃;

fluorophosphates such as Na₂FePO₄F, Na₂VPO₄F, Na₂MnPO₄F, Na₂CoPO₄F, and Na₂NiPO₄F;

fluorosulfates such as NaFeSO₄F, NaMnSO₄F, NaCoSO₄F, and NaFeSO₄F;

borates such as NaFeBO₄ and Na₃Fe₂(BO₄)₃; and

fluorides represented by NaₕM⁵F₆ such as Na₃FeF₆ and Na₂MnF₆ (M⁵ is one or more transition metal elements, 2≦h≦3).

These can be used singly or can be used as a mixture of two or more kinds thereof.

Among them, as a sodium transition metal compound, oxides represented by NaM¹O₂ (M¹ is one or more transition metal elements) are preferable. Specific preferable examples of such oxides include oxides such as NaMnO₂, NaNiO₂, NaCoO₂, and NaFe_{1-p-q}MnₚNi_{q}O₂ (p and q are the value satisfying the following relationship. 0≦p+q≦1, 0≦p≦1, 0≦q≦1), which have the α-NaFeO₂ type structure.

In the sodium transition metal compounds, a part of the transition metal elements may be substituted by a metal element other than the transition metal elements within the range which does not impair the effect of the invention. The characteristics of the battery of the present invention are improved by the substitution in some cases. The metals other than the transition metal elements include metal elements such as Li, K, Ag, Mg, Ca, Sr, Ba, Al, Ga, In, Zn, Sc, Y, La, Ce, Pr, Nd, Sm, Eu, Gd, Tb, Ho, Er, Tm, Yb, and Lu.

### <Positive Current Collector: When Second Electrode is Positive Electrode>

The positive current collector should have high electric conductivity and is easily processed into a thin film, and metals such as Al, Ni, stainless steel, and Cu can be used. Examples of the form of the positive current collector include foil, flat plate, mesh, net, lath, perforated metal, embossed, and combinations thereof (e.g., mesh-like flat plate).

### <Positive Electrode Mixture: When Second Electrode is Positive Electrode>

The positive electrode mixture may contain a conductive material, and a carbonaceous material can be used as the conductive material. An example of the carbonaceous material includes a graphite powder, carbon black, and fibrous carbonaceous materials such as carbon nanotube. The ratio of the conductive material in the electrode mixture is usually in the range of from 5 parts by weight to 20 parts by weight, based on 100 parts by weight of the electrode active material. When a fine-particle carbonaceous material or fibrous carbonaceous material as described above is used as the conductive material, it is also possible to reduce this ratio. An examples of the binder used in the positive electrode includes the same one as the binder used in the first electrode in the present invention.

<Method for Producing Positive Electrode: when Second Electrode is Positive Electrode>

The positive electrode can be produced by supporting, on a positive current collector, a positive electrode mixture containing a positive electrode active material which can be doped and dedoped with a sodium ion. Examples of the method for supporting a positive electrode mixture on a positive current collector include a method of preparing a positive electrode mixture paste comprising a positive electrode active material, a conductive material, a binder, and a solvent, kneading the positive electrode mixture paste, and then applying the obtained positive electrode mixture paste on a current collector, followed by drying. The method of applying a positive electrode mixture paste on a current collector is not particularly limited. Examples include a slit die coating method, a screen coating method, a curtain coating method, a knife coating method, a gravure coating method, and an electrostatic spray method. Also, drying after the application may be carried out by heat treatment, and may be carried out by air blast drying, vacuum drying, and the like. When drying is carried out by heat treatment, the temperature is usually in the range of from about 50° C. to about 150° C. Also, pressing may be carried out after drying. The press method includes methods such as metal mold press and roll press. The electrode can be produced by the above-mentioned method. Also, the thickness of the electrode mixture is usually in the range of from about 5 μm to about 500 μm.

### <When Second Electrode is Negative Electrode>

When a second electrode has a sodium metal or sodium alloy, the second electrode acts as a negative electrode, and the first electrode acts as a positive electrode. In this case, the sodium metal or sodium alloy is mainly used solely as an electrode (for example, used in the form of foil).

### <Separator>

As the separator, for example, there can be used materials having a form of porous film, non-woven fabric, woven fabric or the like, and made of a material such as a polyolefin resin such as polyethylene and polypropylene, a fluorine resin, or nitrogen-containing aromatic polymer. The separator may be a single layer or laminated separator using two or more kinds of these materials. Examples of the separator include separators described in JP2000-30686A, JP10-324758A, or the like. It is preferred that the thickness of the separator be thinner as long as mechanical strength is maintained, from the viewpoint of increasing the volumetric energy density of a battery and decreasing internal resistance. In general, the thickness of the separator is preferably in the range of from about 5 μm to about 200 μm and more preferably in the range of from about 5 μm to about 40 μm.

The separator preferably has a porous film containing a thermoplastic resin. It is generally important that the secondary battery have a function by which, when an abnormal current flows in the battery due to short circuit between a positive electrode and a negative electrode, or the like, the current is interrupted to block (shutdown) the flow of excessive current. Therefore, it is desired that the separator shutdown at the lowest temperature as possible when exceeding usual use temperature (when the separator has a porous film containing a thermoplastic resin, it is carried out by obstructing micropores of the porous film), and even if the temperature in the battery increases to a certain high temperature after shutdown, the separator maintain shutdown state without being ruptured due to the increased temperature, in other words, have high heat resistance. By using the separator having a laminated porous film in which a heat resistant porous layer containing a heat resistant resin and a porous film containing a thermoplastic resin are laminated as a separator, it is possible to further prevent thermal destruction of the film in the secondary battery of the present invention. Herein, the heat resistant porous layer may be laminated on both surfaces of the porous film.

### <Laminated Porous Film Separator>

Hereinbelow, the separator comprising a laminated porous film in which a heat resistant porous layer containing a heat resistant resin and a porous film containing a thermoplastic resin are laminated will be described. Herein, the thickness of this separator is usually 40 μm or less and preferably 20 μm or less. In addition, it is preferred that the value of A/B be from 0.1 to 1 when the thickness of the heat resistant porous layer is denoted by A (μm) and the thickness of the porous film is denoted by B (μm). Furthermore, from the viewpoint of ion permeability, this separator has an air permeability according to the Gurley method of preferably in the range of from 50 sec/100 cc to 300 sec/100 cc and further preferably in the range of from 50 sec/100 cc to 200 sec/100 cc. This separator has a porosity of usually in the range of from 30% by volume to 80% by volume and preferably in the range of from 40% by volume to 70% by volume.

### <Heat Resistant Porous Layer>

In a laminated porous film, a heat resistant porous layer contains a heat resistant resin. For enhancing ion permeability, the thickness of the heat resistant porous layer is as thin as preferably in the range of from 1 μm to 10 μm, further preferably in the range of from 1 μm to 5 μm, and particularly preferably in the range of from 1 μm to 4 μm. In addition, the heat resistant porous layer has micropores, and the pore size (diameter) is usually 3 μm or less and preferably 1 μm or less. Further, the heat resistant porous layer can contain the filler described later.

An example of the heat resistant resin contained in the heat resistant porous layer includes polyamides, polyimides, polyamideimides, polycarbonates, polyacetals, polysulfones, polyphenylene sulfides, polyether ether ketones, aromatic polyesters, polyether sulfones, and polyetherimides, and in order to further enhance heat resistance, polyamides, polyimides, polyamideimides, polyether sulfones and polyetherimides are preferable, and polyamides, polyimides and polyamideimides are more preferable. As the heat resistant resin, nitrogen-containing aromatic polymers such as aromatic polyamides (para-oriented aromatic polyamide, meta-oriented aromatic polyamide), aromatic polyimides and aromatic polyamideimides are further more preferable, aromatic polyamides are especially preferable, and para-oriented aromatic polyamide (hereinafter, referred to as para-aramid in some cases) is particularly preferable. In addition, an example of the heat resistant resin also includes poly-4-methylpentene-1 and cyclic olefin-based polymers. By using these heat resistant resins, the heat resistance can be enhanced, that is, the thermal film-breaking temperature can be enhanced.

The thermal film-breaking temperature depends on the type of the heat resistant resin, and the thermal film-breaking temperature is usually 160° C. or more. The thermal film-breaking temperature can be increased to a maximum of about 400° C. by using the above-described nitrogen-containing aromatic polymer as the heat resistant resin. In addition, the thermal film-breaking temperature can be increased to a maximum of about 250° C. when poly-4-methylpentene-1 is used, and to a maximum of about 300° C. when a cyclic olefin-based polymer is used, respectively.

The para-aramid is obtained by polycondensation of a para-oriented aromatic diamine and a para-oriented aromatic dicarboxylic halide, and comprises substantially a repeating unit in which an amide bond is linked at a para-position or according orientation position of an aromatic ring (e.g., 4,4′-positions in biphenylene, 1,5-positions in naphthalene, and 2,6-positions in naphthalene). Specifically, examples of the para-aramids include para-aramids having a para-orientation type structure or a structure according to the para-orientation type, such as poly(para-phenyleneterephthalamide), poly(para-benzamide), poly(4,4′-benzanilide terephthalamide), poly(para-phenylene-4,4′-biphenylene dicarboxylic amide), poly(para-phenylene-2,6-naphthalene dicarboxylic amide), poly(2-chloro-para-phenyleneterephthalamide), and para-phenyleneterephthalamide/2,6-dichloro para-phenyleneterephthalamide copolymer.

The aromatic polyimide is preferably a wholly aromatic polyimide produced by polycondensation of an aromatic diacid anhydride and a diamine. Specific examples of the diacid anhydride include pyromellitic dianhydride, 3,3′,4,4′-diphenylsulfone tetracarboxylic dianhydride, 3,3′,4,4′-benzophenone tetracarboxylic dianhydride, 2,2′-bis(3,4-dicarboxyphenyl)hexafluoropropane, and 3,3′,4,4′-biphenyl tetracarboxylic dianhydride. The diamine includes oxydianiline, para-phenylenediamine, benzophenonediamine, 3,3′-methylenedianiline, 3,3′-diaminobenzophenone, 3,3′-diaminodiphenylsulfone, and 1,5-naphthalenediamine. In addition, solvent-soluble polyimides can be suitably used. Examples of such polyimide include a polyimide which is a polycondensate of 3,3′,4,4′-diphenylsulfone tetracarboxylic dianhydride and an aromatic diamine.

The aromatic polyamideimide includes those obtained by polycondensation of an aromatic dicarboxylic acid and an aromatic diisocyanate and those obtained by polycondensation of an aromatic diacid anhydride and an aromatic diisocyanate. Specific examples of the aromatic dicarboxylic acid include isophthalic acid and terephthalic acid. Also, specific examples of the aromatic diacid anhydride include trimellitic anhydride. Specific examples of the aromatic diisocyanate include 4,4′-diphenylmethane diisocyanate, 2,4-tolylene diisocyanate, 2,6-tolylene diisocyanate, ortho-tolylene diisocyanate, and m-xylene diisocyanate.

The filler that may be contained in the heat resistant porous layer may be one selected from an organic powder, an inorganic powder, and a mixture thereof. It is preferred that particles constituting a filler have an average particle size of from 0.01 to 1 μm. The shape of the filler includes an approximately spherical shape, a plate shape, a column shape, a needle shape, a whisker shape, and a fiber shape, and approximately spherical particles are preferable since uniform pores are likely to be formed.

Examples of the organic powder as a filler include powders made of organic substances such as homopolymers or copolymers of two or more of styrene, vinyl ketone, acrylonitrile, methyl methacrylate, ethyl methacrylate, glycidyl methacrylate, glycidyl acrylate, and methyl acrylate; fluorine resins such as polytetrafluoroethylene, ethylene tetrafluoride-propylene hexafluoride copolymer, ethylene tetrafluoride-ethylene copolymer and polyvinylidene fluoride; melamine resins; urea resins; polyolefins; and polymethacrylate. The organic powders may be used singly or can be used as a mixture of two or more thereof. Among these organic powders, a polytetrafluoroethylene powder is preferable from the viewpoint of chemical stability.

Examples of the inorganic powder as a filler include powders made of inorganic substances such as metal oxides, metal nitrides, metal carbides, metal hydroxides, carbonates, and sulfates, and specific examples include powders made of alumina, silica, titanium dioxide, calcium carbonate, and the like. The inorganic powders may be used singly or can be used as a mixture of two or more thereof. Among these inorganic powders, an alumina powder is preferable from the viewpoint of chemical stability. It is more preferred that all particles constituting a filler be alumina particles and it is further more preferred that all particles constituting a filler be alumina particles and a part of or all of them be approximately spherical alumina particles.

The content of the filler in the heat resistant porous layer depends on the specific gravity of the material of the filler, and for example, when all particles constituting a filler are alumina particles, the weight of the filler is usually in the range of from 20 parts by weight to 95 parts by weight, and more preferably in the range of from 30 parts by weight to 90 parts by weight, when the total weight of the heat resistant porous layer is defined as 100. These ranges can be appropriately set depending on the specific gravity of the material of the filler.

### <Porous Film>

In a laminated porous film, a porous film contains a thermoplastic resin. The thickness of this porous film is usually in the range of from 3 μm to 30 μm and further preferably in the range of from 3 μm to 20 μm. The porous film has micropores, as is the case with the heat resistant porous layer, and the pore size is usually 3 μm or less and preferably 1 μm or less. The porous film has a porosity of usually in the range of from 30% by volume to 80% by volume and preferably in the range of from 40% by volume to 70% by volume. In the non-aqueous electrolyte secondary battery, when exceeding the usual use temperature, the porous film can obstruct micropores by softening of the thermoplastic resin constituting the film.

The thermoplastic resin contained in the porous film includes those softened at 80° C. to 180° C., and those which are not dissolved in an electrolytic solution of a non-aqueous electrolyte secondary battery should be selected. Specifically, an example of the thermoplastic resin includes polyolefin such as polyethylene and polypropylene, and thermoplastic polyurethane, and a mixture of two or more of these compounds may be used. In order to soften at lower temperature to cause shutdown, the thermoplastic resin is preferably polyethylene. Specifically, an example of the polyethylene includes polyethylenes such as low density polyethylene, high density polyethylene, and linear polyethylene, and also includes ultrahigh molecular weight polyethylenes. In order to enhance the puncture strength of a porous film, it is preferred that the thermoplastic resin at least contain an ultrahigh molecular weight polyethylene. In addition, in the production aspect of the porous film, the thermoplastic resin preferably contains a wax made of a polyolefin of low molecular weight (weight average molecular weight of 10000 or less) in some cases.

### EXAMPLES

Hereinbelow, the present invention will be described in more detail by way of examples, but the present invention is not limited to the following examples as long as the gist thereof is not changed. Incidentally, unless otherwise noted, the method for preparing an electrode and sodium secondary battery for charge and discharge test is as described below.

### Production Example 1

### Production of Non-Activated Carbonaceous Material C¹

ICB manufactured by Nippon Carbon Co., Ltd. (trade name: NICABEADS) was introduced to a firing furnace, and the interior of the furnace was turned into an argon gas atmosphere. Thereafter, the temperature was increased from room temperature to 1600° C. at a rate of 5° C. per minute while argon gas was passed through at a rate of 0.1 L/g (weight of a carbonaceous material) per minute, and maintained at 1600° C. for 1 hour, then cooled. Non-Activated Carbonaceous Material C¹ subjected to a surface treatment was obtained.

### Production Example 2

### Production of Non-Activated Carbonaceous Material C²

Into a four-neck flask, 200 g of resorcinol, 1.5 L of methyl alcohol and 194 g of benzaldehyde were charged under a nitrogen stream, followed by ice-cooling, and 36.8 g of 36% hydrochloric acid was added dropwise with stirring. After the completion of dropwise addition, the temperature was raised to 65° C., and kept at the same temperature for 5 hours. To the resulting reaction mixture, 1 L of water was added, and the precipitate was collected by filtration, washed with water until the filtrate became neutral, and dried to obtain 294 g of tetraphenylcalix[4]resorcinarene (PCRA). The atmosphere in a rotary kiln was replaced with argon, and the PCRA was heated at 1000° C. for 4 hours. Subsequently, the PCRA was pulverized in a ball mill (agate-made ball, 28 rpm, 5 minutes), then introduced to a firing furnace, and the interior of the furnace was turned into an argon gas atmosphere. Thereafter, the temperature was increased from room temperature to 1600° C. at a rate of 5° C. per minute while argon gas was passed through at a rate of 0.1 L/g (weight of a carbonaceous material) per minute, and maintained at 1600° C. for 1 hour, then cooled. Non-Activated Carbonaceous Material C² subjected to a surface treatment was obtained.

### Production Example 3

### Production of Non-Activated Carbonaceous Material C³

The interior of a ring furnace was turned into a nitrogen atmosphere, then phenolphthalein (special grade chemical purchased from Wako Pure Chemical Industries, Ltd.) was heated from room temperature to 1000° C. at a rate of 5° C. per minute while nitrogen gas was passed through at a rate of 0.1 L/g (weight of phenolphthalein) per minute, subsequently maintained at 1000° C. for 1 hour while nitrogen gas was passed through at a rate of 0.1 L/g (weight of phenolphthalein) per minute, then cooled, to obtain a carbonaceous material. Subsequently, the resulting carbonaceous material was pulverized in a ball mill (agate-made ball, 28 rpm, 5 minutes), then introduced to a firing furnace, and the interior of the furnace was turned into an argon gas atmosphere. Thereafter, the temperature was increased from room temperature to 1600° C. at a rate of 5° C. per minute while argon gas was passed through at a rate of 0.1 L/g (weight of a carbonaceous material) per minute, and maintained at 1600° C. for 1 hour, then cooled. Non-Activated Carbonaceous Material C³ subjected to a surface treatment was obtained.

### Production Example 4

### Production of Electrode Active Material A¹

In a polypropylene beaker, 44.88 g of potassium hydroxide was added to 300 ml of distilled water, and potassium hydroxide was completely dissolved by stirring to prepare an aqueous potassium hydroxide solution (precipitant). In addition, in another polypropylene beaker, 21.21 g of iron(II) chloride tetrahydrate, 19.02 g of nickel(II) chloride hexahydrate and 15.83 g of manganese(II) chloride tetrahydrate were added to 300 ml of distilled water and dissolved by stirring to obtain an iron-nickel-manganese-containing aqueous solution. The iron-nickel-manganese-containing aqueous solution was added dropwise to the precipitant with stirring, to obtain a slurry formed by a precipitate. Subsequently, the slurry was subjected to filtration, washed with distilled water, and dried at 100° C. to obtain a precipitate. The precipitate and sodium carbonate were weighed out so as to have a molar ratio of Fe:Na=0.4:1, then dry-mixed using an agate mortar to obtain a mixture. Next, the mixture was placed in an alumina calcination vessel and maintained at 900° C. for 6 hours in an air atmosphere using an electric furnace to calcine the mixture and was cooled to room temperature to obtain Electrode Active Material A¹. As a result of powder X-ray diffractometry of Electrode Active Material A¹, it was found to be belonged to the α-NaFeO₂ type crystal structure. Also, as a result of composition analysis of Electrode Active Material A¹ by ICP-AES, the molar ratio of Na:Fe:Ni:Mn was 1:0.4:0.3:0.3.

### Preparation of First Electrode S¹

An electrode mixture paste using Non-Activated Carbonaceous Material C¹ of Production Example 1, sodium polyacrylate (PAANa) (manufactured by Wako Pure Chemical Industries, Ltd., degree of polymerization of 22,000 to 70,000) as a binder, and water as a solvent was prepared. A binder solution obtained by dissolving the binder in water was prepared, weighed out so as to have a composition of Non-Activated Carbonaceous Material C¹:PAANa:water=97:3:150 (weight ratio), and stirred and mixed using a dispermat (manufactured by VMA-GETZMANN GMBH) to obtain an electrode mixture paste. The rotational condition of the rotary blades was set at 2,000 rpm for 5 minutes. The resulting electrode mixture paste was applied on a copper foil using a doctor blade and dried at 60° C. for 2 hours, and then rolled at 125 kN/m using a roll press, to obtain First Electrode S¹.

### Preparation of First Electrode S²

An electrode mixture paste using Non-Activated Carbonaceous Material C¹ of Production Example 1, carboxymethylcellulose (CMC) (manufactured by Dai-ichi Kogyo Seiyaku Co., Ltd., Cellogen 4H) and styrene-butadiene rubber (SBR) (manufactured by NIPPON A&L INC., AL3001) as binders, and water as a solvent was prepared. A binder solution obtained by dissolving the binder in water was prepared, weighed out so as to have a composition of Non-Activated Carbonaceous Material C¹:CMC:SBR:water=97:2:1:150 (weight ratio), and the same operations as in the preparation of First Electrode S¹ were carried out to obtain First Electrode S².

### Preparation of First Electrode S³

An electrode mixture paste using Non-Activated Carbonaceous Material C¹ of Production Example 1, carboxymethylcellulose (CMC) (manufactured by Dai-ichi Kogyo Seiyaku Co., Ltd., Cellogen 4H) as a binder, and water as a solvent was prepared. A binder solution obtained by dissolving the binder in water was prepared, weighed out so as to have a composition of Non-Activated Carbonaceous Material C¹:CMC:water=97:3:150 (weight ratio), and the same operations as in the preparation of First Electrode S¹ were carried out to obtain First Electrode S³.

### Preparation of First Electrode S⁴

An electrode mixture paste using Non-Activated Carbonaceous Material C² of Production Example 2, PAANa (manufactured by Wako Pure Chemical Industries, Ltd., degree of polymerization of 22,000 to 70,000) as a binder, and water as a solvent was prepared. A binder solution obtained by dissolving the binder in water was prepared, weighed out so as to have a composition of Non-Activated Carbonaceous Material C²:PAANa:water=97:3:150 (weight ratio), and the same operations as in the preparation of First Electrode S¹ were carried out to obtain First Electrode S⁴.

### Preparation of First Electrode S⁵

An electrode mixture paste using Non-Activated Carbonaceous Material C³ of Production Example 3, PAANa (manufactured by Wako Pure Chemical Industries, Ltd., degree of polymerization of 22,000 to 70,000) as a binder, and water as a solvent was prepared. A binder solution obtained by dissolving the binder in water was prepared, weighed out so as to have a composition of Non-Activated Carbonaceous Material C³:PAANa:water=97:3:150 (weight ratio), and the same operations as in the preparation of First Electrode S¹ were carried out to obtain First Electrode S⁵.

### Preparation of Second Electrode D¹

There were used Electrode Active Material A¹ of Production Example 4 as an electrode active material, acetylene black (HS100, manufactured by DENKI KAGAKU KOGYO KABUSHIKI KAISHA) as a conductive material, a fluorine resin (manufactured by Daikin Industries, Ltd., VT471) as a binder. The binder was dissolved in NMP so as to have a composition of binder:NMP=5:95 (weight ratio), and then used. A composition having a weight ratio of Electrode Active Material A¹:conductive material:binder:NMP=90:5:5:100 was stirred and mixed using T.K. FILMICS 30-25 (manufactured by PRIMIX Corporation), to obtain an electrode mixture paste. The rotational conditions of the rotary blades was set at 5,000 rpm for 3 minutes. The resulting electrode mixture paste was applied on an aluminum foil having a thickness of 20 μm using a doctor blade and dried at 60° C. for 2 hours, and then rolled at 200 kN/m using a roll press, to obtain Second Electrode D¹.

### Example 1

### Preparation of Sodium Secondary Battery B¹

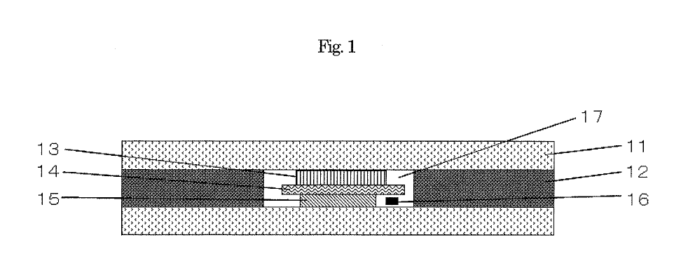

Using First Electrode S² as a first electrode and a metal sodium (manufactured by Aldrich Chemical Company, Inc.) as a second electrode, a three-electrode cell schematically shown in FIG. 1 was prepared. Using a polyethylene porous film (thickness of 20 μm) as a separator, an electrode obtained by adhering the metal sodium at a tip of a nickel lead was set as a reference electrode. A mixed solution of 1 mol/L of NaPF₆/propylene carbonate solution (1 M NaPF₆/PC) (manufactured by Kishida Chemical Co., Ltd.) and fluoroethylene carbonate (bEC), a cyclic carbonate containing fluorine, (manufactured by Kishida Chemical Co., Ltd.) at a volume ratio of 95.2:4.8 was added dropwise as a non-aqueous electrolytic solution so that the electrode was immersed, then a SUS plate was used for sealing, to prepare Three-Electrode Type Sodium Secondary Battery B¹. Assembly of the battery was performed in a glove box under an argon atmosphere.

### Example 2

### Preparation of Sodium Secondary Battery B²

The same operations as in Example 1 were carried out except for using a mixed solution of 1 M NaPF₆/PC (manufactured by Kishida Chemical Co., Ltd.) and FEC, a cyclic carbonate containing fluorine, (manufactured by Kishida Chemical Co., Ltd.) at a volume ratio of 99.0:1.0 as a non-aqueous electrolytic solution, to prepare Sodium Secondary Battery B².

### Comparative Example 1

### Preparation of Sodium Secondary Battery E¹

The same operations as in Example 1 were carried out except for using 1 M NaPF₆/PC (manufactured by Kishida Chemical Co., Ltd.) as a non-aqueous electrolytic solution, to prepare Sodium Secondary Battery E¹.

### Charge and Discharge Test of Sodium Secondary Batteries B¹, B² and E¹

Before charge and discharge test, a treatment for stabilizing an operation of sodium secondary batteries B¹, B² and E¹ (Stabilization Treatment 1) was carried out, and then charge and discharge test (Charge and Discharge Test 1) was performed.

<Stabilization Test 1>

Two cycles of the electrification treatment in which the charge was performed by CC-CV (constant current-constant voltage, charge completion by attaining 0.005 C current value) charge until a potential of the first electrode on the reference electrode attains from a rest potential to 0.005 V at a 0.05 C rate (a rate that takes 20 hours for full charge), and then the discharge was performed by CC (constant current) discharge up to 1.5 V at a 0.05 C rate, were performed.

<Charge and Discharge Test 1>

After performing Stabilization Treatment 1, a charge and discharge test was performed in the following conditions. The charge was performed by CC-CV charge (charge completion by attaining 0.01 C current value) until a potential of the first electrode on the reference electrode attains to 0.005 V at a 0.1 C rate (a rate that takes 10 hours for full charge), then a charge and discharge test performing CC discharge up to 1.5 V at a 0.1 C rate was performed. The result of charge and discharge test of Sodium Secondary Batteries B¹, B² and E¹ are shown in Table 1. The discharge capacity is shown as a specific capacity when the discharge capacity of Sodium Secondary Battery E¹ of Comparative Example (discharge capacity per the weight of Electrode Active Substance C¹ contained in First Electrode S²) is regarded as 100. It was found based on Table 1 that the discharge capacity increases as a sodium secondary battery by containing a cyclic carbonate containing fluorine.

TABLE 1

| | Secondary | First | Second | | Specific |
|---|---|---|---|---|---|
| | Battery | Electrode | Electrode | FEC | Capacity |
| Example 1 | B¹ | S² | Na Metal | 4.8 | 115 |
| Example 2 | B² | S² | Na Metal | 1.0 | 119 |
| Comparative | E¹ | S² | Na Metal | 0 | 100 |
| Example 1 | | | | | |

### Example 3

### Preparation of Sodium Secondary Battery B³

First Electrode S¹ punched out into a diameter of 14.5 mm was placed in a recess of the bottom part of a coin cell (manufactured by Hohsen Corp.), using a mixed solution of 1 mol/L of NaPF₆/propylene carbonate solution (1 M NaPF₆/PC) (manufactured by Kishida Chemical Co., Ltd.) and fluoroethylene carbonate (FEC), a cyclic carbonate containing fluorine, (manufactured by Kishida Chemical Co., Ltd.) at a volume ratio of 98.0:2.0 as a non-aqueous electrolytic solution, a polyethylene porous film (thickness: 20 μm) as a separator and a sodium metal (manufactured by Aldrich Chemical Company, Inc.) as a second electrode were combined to prepare Sodium Secondary Battery B³. Assembly of the battery was performed in a glove box under an argon atmosphere.

### Example 4

### Preparation of Sodium Secondary Battery B⁴

The same operations as in Example 3 were carried out except for using a mixed solution of 1 M NaPF₆/PC (manufactured by Kishida Chemical Co., Ltd.) and FEC, a cyclic carbonate containing fluorine, (manufactured by Kishida Chemical Co., Ltd.) at a volume ratio of 95.2:4.8 as a non-aqueous electrolytic solution, to prepare Sodium Secondary Battery B⁴.

### Example 5

### Preparation of Sodium Secondary Battery B⁵

The same operations as in Example 3 were carried out except for using a mixed solution of 1 M NaPF₆/PC (manufactured by Kishida Chemical Co., Ltd.), FEC, a cyclic carbonate containing fluorine, (manufactured by Kishida Chemical Co., Ltd.) and vinylene carbonate (VC), a cyclic carbonate containing a unsaturated bond, (manufactured by Kishida Chemical Co., Ltd.) at a volume ratio of 97.1:1.9:1.0 as a non-aqueous electrolytic solution, to prepare Sodium Secondary Battery B⁵.

### Comparative Example 2

### Preparation of Sodium Secondary Battery E²

The same operations as in Example 3 were carried out except for using 1 M NaPF₆/PC (manufactured by Kishida Chemical Co., Ltd.) as a non-aqueous electrolytic solution, to prepare Sodium Secondary Battery E².

### Example 6

### Preparation of Sodium Secondary Battery B⁶

First Electrode S² punched out into a diameter of 14.5 mm was placed in a recess of the bottom part of a coin cell (manufactured by Hohsen Corp.), using a mixed solution of 1 M NaPF₆/PC (manufactured by Kishida Chemical Co., Ltd.) and FEC, a cyclic carbonate containing fluorine, (manufactured by Kishida Chemical Co., Ltd.) at a volume ratio of 98.0:2.0 as a non-aqueous electrolytic solution, a polyethylene porous film (thickness: 20 μm) as a separator and a sodium metal (manufactured by Aldrich Chemical Company, Inc.) as a second electrode were combined to prepare Sodium Secondary Battery B⁶. Assembly of the battery was performed in a glove box under an argon atmosphere.

### Comparative Example 3

### Preparation of Sodium Secondary Battery E³

The same operations as in Example 6 were carried out except for using 1 M NaPF₆/PC (manufactured by Kishida Chemical Co., Ltd.) as a non-aqueous electrolytic solution, to prepare Sodium Secondary Battery E³.

### Example 7

### Preparation of Sodium Secondary Battery B⁷

First Electrode S³ punched out into a diameter of 14.5 mm was placed in a recess of the bottom part of a coin cell (manufactured by Hohsen Corp.), using a mixed solution of 1 M NaPF₆/PC (manufactured by Kishida Chemical Co., Ltd.) and FEC, a cyclic carbonate containing fluorine, (manufactured by Kishida Chemical Co., Ltd.) at a volume ratio of 98.0:2.0 as a non-aqueous electrolytic solution, a polyethylene porous film (thickness: 20 μm) as a separator and a sodium metal (manufactured by Aldrich Chemical Company, Inc.) as a second electrode were combined to prepare Sodium Secondary Battery B⁷. Assembly of the battery was performed in a glove box under an argon atmosphere.

### Comparative Example 4

### Preparation of Sodium Secondary Battery E⁴

The same operations as in Example 7 were carried out except for using 1 M NaPF₆/PC (manufactured by Kishida Chemical Co., Ltd.) as a non-aqueous electrolytic solution, to prepare Sodium Secondary Battery E⁴.

### Example 8

### Preparation of Sodium Secondary Battery B⁸

First Electrode S⁴ punched out into a diameter of 14.5 mm was placed in a recess of the bottom part of a coin cell (manufactured by Hohsen Corp.), using a mixed solution of 1 M NaPF₆/PC (manufactured by Kishida Chemical Co., Ltd.) and FEE, a cyclic carbonate containing fluorine, (manufactured by Kishida Chemical Co., Ltd.) at a volume ratio of 99.0:1.0 as a non-aqueous electrolytic solution, a polyethylene porous film (thickness: 20 μm) as a separator and a sodium metal (manufactured by Aldrich Chemical Company, Inc.) as a second electrode were combined to prepare Sodium Secondary Battery B⁸. Assembly of the battery was performed in a glove box under an argon atmosphere.

### Example 9

### Preparation of Sodium Secondary Battery B⁹

The same operations as in Example 8 were carried out except for using a mixed solution of 1 M NaPF₆/PC (manufactured by Kishida Chemical Co., Ltd.) and EEC, a cyclic carbonate containing fluorine, (manufactured by Kishida Chemical Co., Ltd.) at a volume ratio of 92.6:7.4 as a non-aqueous electrolytic solution, to prepare Sodium Secondary Battery B⁹.

### Comparative Example 5

### Preparation of Sodium Secondary Battery E⁵

The same operations as in Example 8 were carried out except for using 1 M NaPF₆/PC (manufactured by Kishida Chemical Co., Ltd.) as a non-aqueous electrolytic solution, to prepare Sodium Secondary Battery E⁵.

### Example 10

### Preparation of Sodium Secondary Battery B¹⁰

First Electrode S⁵ punched out into a diameter of 14.5 mm was placed in a recess of the bottom part of a coin cell (manufactured by Hohsen Corp.), using a mixed solution of 1 M NaPF₆/PC (manufactured by Kishida Chemical Co., Ltd.) and FEC, a cyclic carbonate containing fluorine, (manufactured by Kishida Chemical Co., Ltd.) at a volume ratio of 98.0:2.0 as a non-aqueous electrolytic solution, a polyethylene porous film (thickness: 20 μm) as a separator and a sodium metal (manufactured by Aldrich Chemical Company, Inc.) as a second electrode were combined to prepare Sodium Secondary Battery B¹⁰. Assembly of the battery was performed in a glove box under an argon atmosphere.

### Comparative Example 6

### Preparation of Sodium Secondary Battery E⁶

The same operations as in Example 10 were carried out except for using 1 M NaPF₆/PC (manufactured by Kishida Chemical Co., Ltd.) as a non-aqueous electrolytic solution, to prepare Sodium Secondary Battery E⁶.

### Charge and Discharge Test of Sodium Secondary Batteries B³ to B¹⁰ and E² to E⁶

Before charge and discharge test, a treatment for stabilizing (Stabilization Treatment 2) an operation of sodium secondary batteries B³ to B¹⁰ and E² to E⁶ was carried out, and then a charge and discharge test (Charge and Discharge Test 2) was performed.

<Stabilization Treatment 2>

Two cycles of the electrification treatment in which the charge was performed by CC-CV (constant current-constant voltage, charge completion by attaining 0.005 C current value) charge from a rest potential to 0.005 V at a 0.05 C rate (a rate that takes 20 hours for full charge), and then the discharge was performed by CC (constant current) discharge up to 1.5 V at a 0.1 C rate (a rate that takes 10 hours for full charge), were performed. Further, three cycles of the electrification treatment in which the CC-CV charge (charge completion by attaining 0.01 C current value) was performed up to 0.005 V at a 0.1 C rate, and then the CC discharge was performed up to 1.5 V at a 0.1 C rate, were performed. Subsequently, two cycles of the electrification treatment in which the CC-CV charge (charge completion by attaining 0.01 C current value) was performed up to 0.005 V at a 0.1 C rate, and then the CC discharge was performed up to 1.5 V at a 0.2 C rate, were performed.

<Charge and Discharge Test 2>

After performing Stabilization Treatment 2, a charge and discharge test was performed in the following conditions. The CC-CV charge (charge completion by attaining 0.01 C current value) was performed up to 0.005 V at a 0.1 C rate, then a charge and discharge test performing CC discharge up to 1.5 V at a 0.2 C rate was performed. The result of charge and discharge test of a cell using each of First Electrodes S¹ to S⁵ are shown in Tables 2 to 6. The discharge capacity is shown as a specific capacity when the discharge capacity of Sodium Secondary Batteries E² to E⁶ of each Comparative Example (discharge capacity per the weight of Electrode Active Substances C¹ to C³ contained in First Electrode S¹ to S⁵ in each sodium secondary battery) is regarded as 100. It was found based on Tables 2 to 6 that the discharge capacity increases as a sodium secondary battery by containing a cyclic carbonate containing fluorine and/or cyclic carbonates containing an unsaturated bond.

TABLE 2

| | Secondary | First | Second | | | Specific |
|---|---|---|---|---|---|---|
| | Battery | Electrode | Electrode | FEC | VC | Capacity |
| Example 3 | B³ | S¹ | Na Metal | 2.0 | 0 | 111 |
| Example 4 | B⁴ | S¹ | Na Metal | 4.8 | 0 | 103 |
| Example 5 | B⁵ | S¹ | Na Metal | 1.9 | 1.0 | 103 |
| Comparative | E² | S¹ | Na Metal | 0 | 0 | 100 |
| Example 2 | | | | | | |

TABLE 3

| | Secondary | First | Second | | Specific |
|---|---|---|---|---|---|
| | Battery | Electrode | Electrode | FEC | Capacity |
| Example 6 | B⁶ | S² | Na Metal | 2.0 | 130 |
| Comparative | E³ | S² | Na Metal | 0 | 100 |
| Example 3 | | | | | |

TABLE 4

| | Secondary | First | Second | | Specific |
|---|---|---|---|---|---|
| | Battery | Electrode | Electrode | FEC | Capacity |
| Example 7 | B⁷ | S³ | Na Metal | 2.0 | 111 |
| Comparative | E⁴ | S³ | Na Metal | 0 | 100 |
| Example 4 | | | | | |

TABLE 5

| | Secondary | First | Second | | Specific |
|---|---|---|---|---|---|
| | Battery | Electrode | Electrode | FEC | Capacity |
| Example 8 | B⁸ | S⁴ | Na Metal | 1.0 | 142 |
| Example 9 | B⁹ | S⁴ | Na Metal | 7.4 | 119 |
| Comparative | E⁵ | S⁴ | Na Metal | 0 | 100 |
| Example 5 | | | | | |

TABLE 6

| | Secondary | First | Second | | Specific |
|---|---|---|---|---|---|
| | Battery | Electrode | Electrode | FEC | Capacity |
| Example 10 | B¹⁰ | S⁵ | Na Metal | 2.0 | 139 |
| Comparative | E⁶ | S⁵ | Na Metal | 0 | 100 |
| Example 6 | | | | | |

### Example 11

### Preparation of Sodium Secondary Battery B¹¹

Second Electrode D¹ punched out into a diameter of 14.5 mm was placed in a recess of the bottom part of a coin cell (manufactured by Hohsen Corp.), using a mixed solution of 1 M NaPF₆/PC (manufactured by Kishida Chemical Co., Ltd.) and FEC, a cyclic carbonate containing fluorine, (manufactured by Kishida Chemical Co., Ltd.) at a volume ratio of 99.5:0.5 as a non-aqueous electrolytic solution, a polyethylene porous film (thickness: 20 μm) as a separator and First Electrode S² (diameter: 15.0 mm) as a first electrode were combined to prepare Sodium Secondary Battery B¹¹. Assembly of the battery was performed in a glove box under an argon atmosphere.

### Example 12

### Preparation of Sodium Secondary Battery B¹²

The same operations as in Example 11 were carried out except for using a mixed solution of 1 M NaPF₆/PC (manufactured by Kishida Chemical Co., Ltd.) and a cyclic carbonate containing fluorine, (manufactured by Kishida Chemical Co., Ltd.) at a volume ratio of 98.0:2.0 as a non-aqueous electrolytic solution, to prepare Sodium Secondary Battery B¹².

### Example 13

### Preparation of Sodium Secondary Battery B¹³

The same operations as in Example 11 were carried out except for using a mixed solution of 1 M NaPF₆/PC (manufactured by Kishida Chemical Co., Ltd.) and FEC, a cyclic carbonate containing fluorine, (manufactured by Kishida Chemical Co., Ltd.) at a volume ratio of 95.2:4.8 as a non-aqueous electrolytic solution, to prepare Sodium Secondary Battery B¹³.

### Comparative Example 7

### Preparation of Sodium Secondary Battery E⁷

The same operations as in Example 11 were carried out except for using 1 M NaPF₆/PC (manufactured by Kishida Chemical Co., Ltd.) as a non-aqueous electrolytic solution, to prepare Sodium Secondary Battery E⁷.

### Charge and Discharge Test of Sodium Secondary Batteries B¹¹ to B¹³ and E⁷

Before charge and discharge test, a treatment for stabilizing (Stabilization Treatment 3) an operation of sodium secondary batteries B¹¹ to B¹³ and E⁷ was carried out, and then a charge and discharge test (Charge and Discharge Test 3) was performed.

<Stabilization Treatment 3>

One cycle of the electrification treatment in which the charge was performed by CC charge from a rest potential to 3.2 V at a 0.05 C rate (a rate that takes 20 hours for full charge), and then the discharge was performed by CC (constant current) discharge up to 2.0 V at a 0.1 C rate (a rate that takes 10 hours for full charge), was performed. Further, one cycle of the electrification treatment in which the CC charge was performed up to 3.8 V at a 0.05 C rate, and then the CC discharge was performed up to 2.0 V at a 0.1 C rate, was performed. Subsequently, one cycle of the electrification treatment in which the CC-CV charge (charge completion by attaining 0.005 C current value) was performed up to 4.0 V at a 0.05 C rate, and then the CC discharge was performed up to 2.0 V at a 0.1 C rate, was performed. In addition, one cycle of the electrification treatment in which the CC-CV charge (charge completion by attaining 0.02 C current value) was performed up to 4.0 V at a 0.1 C rate, and then the CC discharge was performed up to 2.0 V at a 0.2 C rate, was performed.

<Charge and Discharge Test 3>

After performing Stabilization Treatment 3, a charge and discharge test was performed in the following conditions. The CC-CV charge (charge completion by attaining 0.02 C current value) was performed up to 4.0 V at a 0.1 C rate, then a charge and discharge test performing CC discharge up to 2.0 V at a 0.2 C rate was performed. The specific capacity is shown in Table 7 when the discharge capacity of Sodium Secondary Battery E⁷ of Comparative Example 7 (discharge capacity per the weight of Electrode Active Substance A¹ contained in Second Electrode D¹) is regarded as 100. It was found based on Table 7 that the discharge capacity increases as a sodium secondary battery by containing a cyclic carbonate containing fluorine.

TABLE 7

| | Secondary | First | Second | | Specific |
|---|---|---|---|---|---|
| | Battery | Electrode | Electrode | FEC | Capacity |
| Example 11 | B¹¹ | S² | D¹ | 0.5 | 103 |
| Example 12 | B¹² | S² | D¹ | 2.0 | 107 |
| Example 13 | B¹³ | S² | D¹ | 4.8 | 102 |
| Comparative | E⁷ | S² | D¹ | 0 | 100 |
| Example 7 | | | | | |

It was found based on Tables 1 to 7 that the discharge capacity of a sodium secondary battery can be increased by using the sodium secondary battery of the present invention.

### Production Example 5

### Production of Laminated Porous Film

### (1) Production of Coating Slurry for Heat Resistant Porous Layer

In 4200 g of NMP was dissolved 272.7 g of calcium chloride, and 132.9 g of para-phenylenediamine was added and completely dissolved. To the resulting solution was slowly added 243.3 g of terephthalic dichloride, and the mixture was polymerized to obtain a para-aramid, and this was diluted further with NMP, to obtain a para-aramid solution having a concentration of 2.0% by weight. To 100 g of the resulting para-aramid solution were added 2 g of the first alumina powder (manufactured by Nippon Aerosil Co., Ltd., Alumina C, average particle size 0.02 μm) and 2 g of the second alumina powder (Sumicorandom manufactured by Sumitomo Chemical Co., Ltd., AA03, average particle size 0.3 μm) as fillers in a total amount of 4 g, and they were mixed and treated three times by a nanomizer, and further, filtrated through a 1000 mesh wire netting and defoamed under a reduced pressure to produce a coating slurry for a heat resistant porous layer. The weight of the alumina powders (fillers) based on the total weight of the para-aramid and the alumina powders was 67% by weight.

### (2) Production and Evaluation of Laminated Porous Film

As the porous film, a polyethylene porous film (film thickness 12 μm, air permeability 140 sec/100 cc, average pore size 0.1 μm, porosity 50%) was used. On a PET film having a thickness of 100 μm, the polyethylene porous film was fixed, and the coating slurry for a heat resistant porous layer was applied on the porous film by a bar coater manufactured by Tester Sangyo Co., Ltd. The product was immersed in water, a poor solvent, while maintaining integration of the PET film and the applied porous film, to precipitate a para-aramid porous membrane (heat resistant porous layer). Thereafter, the solvent was dried, and the PET film was exfoliated to obtain a laminated porous film in which a heat resistant porous layer and a porous film were laminated. The laminated porous film had a thickness of 16 μm, and the para-aramid porous membrane (heat resistant porous layer) had a thickness of 4 μm. The laminated porous film had an air permeability of 180 sec/100 cc and a porosity of 50%. The cross section of the heat resistant porous layer in the laminated porous film was observed by a scanning electron microscope (SEM) to find that the laminated porous film had relatively small micropores of about 0.03 μm to about 0.06 μm and relatively large micropores of about 0.1 μm to about 1 μm. Incidentally, evaluations of the laminated porous film were carried out by the following (A) to (C).

### (A) Measurement of Thickness

The thickness of the laminated porous film and the thickness of the porous film were measured according to JIS standard (K7130-1992). Also, as the thickness of the heat resistant porous layer, a value obtained by subtracting the thickness of the porous film from the thickness of the laminated porous film was used.

### (B) Measurement of Air Permeability by Gurley Method

The air permeability of the laminated porous film was measured by digital timer mode Gurley type Densometer manufactured by Yasuda Seiki Seisakusho Ltd., according to JIS P8117.

### (C) Porosity

A sample of the resulting laminated porous film was cut into a square with a side of 10 cm, and the weight W (g) and the thickness D (cm) thereof were measured. The weight (Wi; i is an integer from 1 to n) of each layer in the sample was measured, and the volume of each layer was calculated from Wi and the true specific gravity (g/cm³) of the material of each layer. The porosity (% by volume) was calculated according to the following formula.

Porosity (% by volume)=100×{1−(W1/True Specific Gravity 1+W2/True Specific Gravity 2++Wn/True Specific Gravity n)/(10×10×D)}

When the laminated porous film like the one obtained in Production Example 5 is used as the separator in the present invention, a sodium secondary battery which can further prevent thermal destruction of the film can be obtained.

### INDUSTRIAL APPLICABILITY

According to the present invention, a sodium secondary battery having high discharge capacity can be provided, and the present invention is industrially very useful.

1. A sodium secondary battery comprising a first electrode comprising a carbonaceous material which can be doped and dedoped with a sodium ion, a second electrode, and a non-aqueous electrolytic solution in which an electrolyte salt is dissolved in a non-aqueous solvent, wherein the non-aqueous electrolytic solution comprises a cyclic carbonate containing an unsaturated bond, a cyclic carbonate containing fluorine, or both, in the range of 0.01% by volume or more and 10% by volume or less relative to the non-aqueous electrolytic solution.

2. The sodium secondary battery according to claim 1, wherein the cyclic carbonate containing fluorine is 4-fluoro-1,3-dioxolane-2-on.

3. The sodium secondary battery according to claim 1, wherein the carbonaceous material is a non-activated carbonaceous material.

4. The sodium secondary battery according to claim 1, further comprising a separator between the first electrode and the second electrode.

5. The sodium secondary battery according to claim 2, wherein the carbonaceous material is a non-activated carbonaceous material.

6. The sodium secondary battery according to claim 2, further comprising a separator between the first electrode and the second electrode.
